(19) United States
(12) Patent Application Publication
(10) Pub. No.: US 2016/0348922 A1
(43) Pub. Date: Dec. 1, 2016

(54) PORTABLE TAILGATING GRILL

(71) Applicant: Zachary KNIGHT, RICHMOND, VA (US)

(72) Inventor: Zachary KNIGHT, RICHMOND, VA (US)

(21) Appl. No.: 14/726,591

(22) Filed: May 31, 2015

(51) Int. Cl. F24C 15/30; A47J 37/07

(52) U.S. Cl. CPC F24C 15/30; A47J 37/0718; A47J 37/0786

(57) ABSTRACT

A portable grill adapted to be supported by a hitch of a vehicle is provided so that the portable grill is disposed outside the vehicle during use and transportation so as to not take up important storage space in the transporting vehicle. The portable grill may include a body pivotally connected to a cooperating lid so as to define a grilling space. The components of the portable grill may be made of 10 gauge steel metal and rigidly interconnected by welds to provide sufficient operable durability. Specifically, the body may provide a rigidly connected lower frame assembly having a hitch tube dimensioned and adapted to securely mount the body to the hitch of vehicle during transport and use.

### BACKGROUND OF THE INVENTION

The present invention relates to barbeque grills and, more particularly, to a portable tailgating grill.

Standard tailgating grills are designed to be stationary grill, and so are not built to be durable, for example they are not typically made of 10 gauge steel and are bolted rather than welded. As a result owners do not get an appropriate return on their monetary investment from the current tailgating grill, and can expect higher maintenance costs over its limited lifetime to boot.

As can be seen, there is a need for a portable tailgating grill durable enough to be transported and used while being connected to a vehicle hitch without taking up important storage space in the transporting vehicle.

### SUMMARY OF THE INVENTION

In one aspect of the present invention, a portable grill for being secured to a vehicle hitch for transportation and use includes a grill body made of a durable material; and a hitch tube made of durable material rigidly connected to a lower portion of the grill body.

In another aspect of the present invention, a portable grill for being secured to a vehicle hitch for transportation and use includes a grill body made of a durable material; a hitch bar made of durable material adapted so that an end thereof is connected to the vehicle hitch, wherein the hitch bar is elongated to afford a predetermined tailgate clearance; a hitch tube made of durable material, wherein the hitch tube is dimensioned and adapted to mount to an opposing end of the hitch bar; at least one hitch tube pin disposed along the length of the hitch tube, wherein each hitch tube pin is adapted to secure the hitch bar within the hitch tube; a lower frame assembly made of a durable material, having a lower frame comprising a plurality of frame members forming a lower opening; and a plurality of vertical columns rigidly interconnecting the lower frame to the grill body, wherein the hitch tube is rigidly connected to opposing frame members; and two reinforcement bars made of durable material, each reinforcement bar being transversely connected to a midpoint of the hitch tube and extending and connected to an adjacent frame member.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention, shown in use, demonstrating tailgate clearance;

FIG. 3 is a front top perspective view of an exemplary embodiment of the present invention;

FIG. 4 is a rear bottom perspective view of an exemplary embodiment of the present invention;

FIG. 5 is a detail view of an exemplary embodiment of the present invention, demonstrating a pivotal connection of a side burner frame;

FIG. 6 is a perspective view of an exemplary embodiment of a dolly assembly of the present invention;

FIG. 7 is a front perspective view of an exemplary embodiment of the present invention, illustrating the dolly assembly in use;

FIG. 8 is a detail view of an exemplary embodiment of the present invention, illustrating a lid gravity latch rotatably movable from a unlocked configuration to a locked configuration;

FIG. 9 is a detail view of an exemplary embodiment of the present invention, illustrating a barrel lock in a closed position;

FIG. 10 is a detail view of an exemplary embodiment of the present invention, illustrating the barrel lock in an opened position;

FIG. 11 is an exploded view of an exemplary embodiment of the present invention; and

FIG. 12 is a section detail view of an exemplary embodiment of the present invention, taken along line 12-12 in FIG. 11.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a portable grill adapted to be supported by a hitch of a vehicle so that the portable grill is disposed outside the vehicle during use and transportation so as to not take up important storage space in the transporting vehicle. The portable grill may include a body pivotally connected to a cooperating lid so as to define a grilling space. The components of the portable grill may be made of 10 gauge steel metal and rigidly interconnected by welds to provide sufficient operable durability. Specifically, the body may provide a rigidly connected lower frame assembly having a hitch tube dimensioned and adapted to securely mount the body to the hitch of vehicle during transport and use.

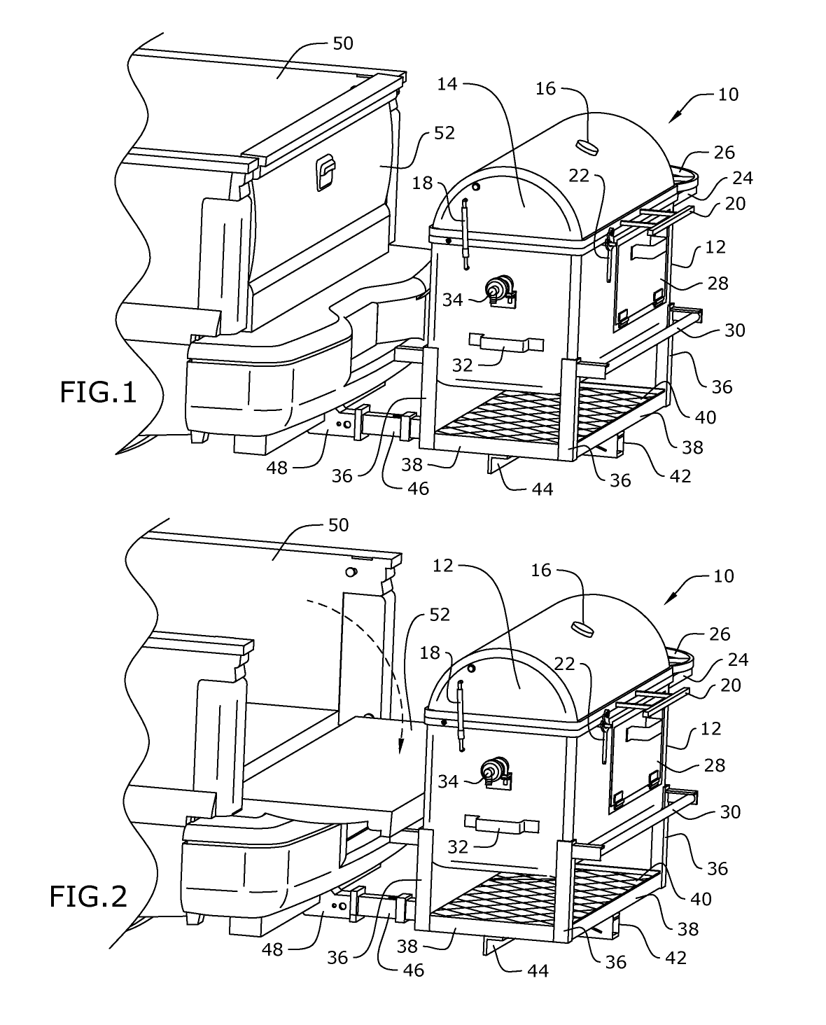

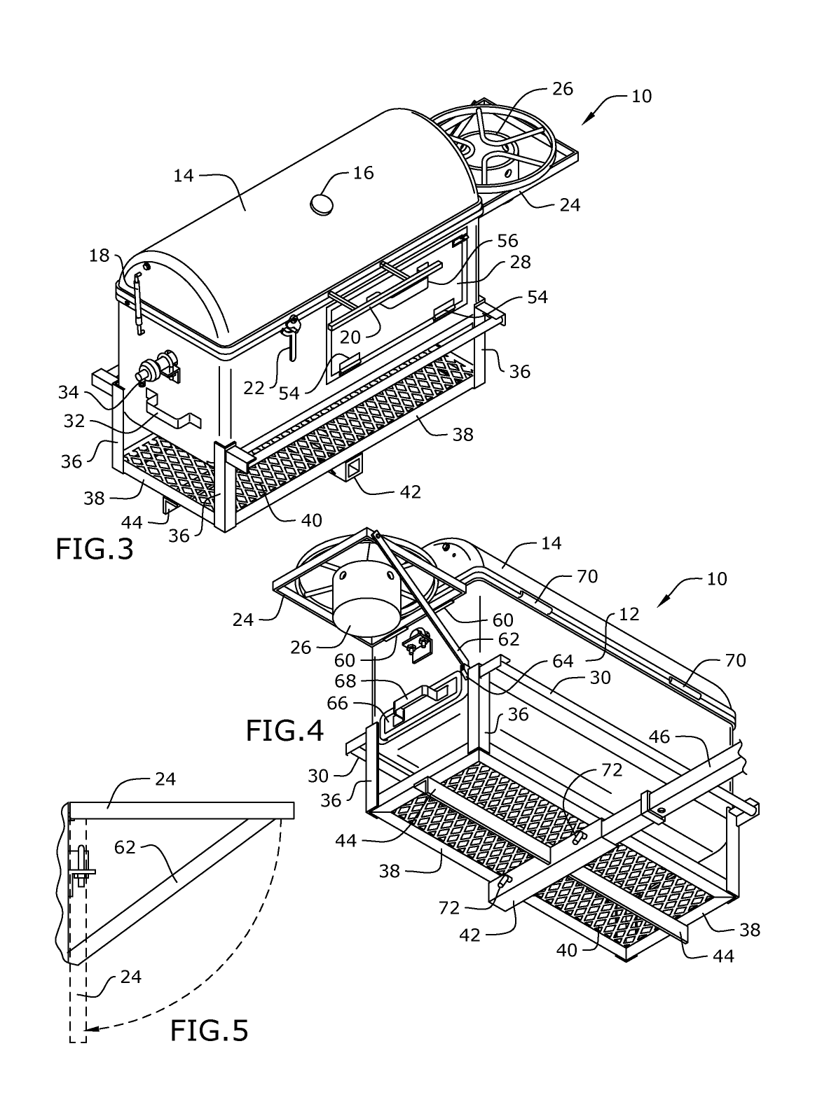

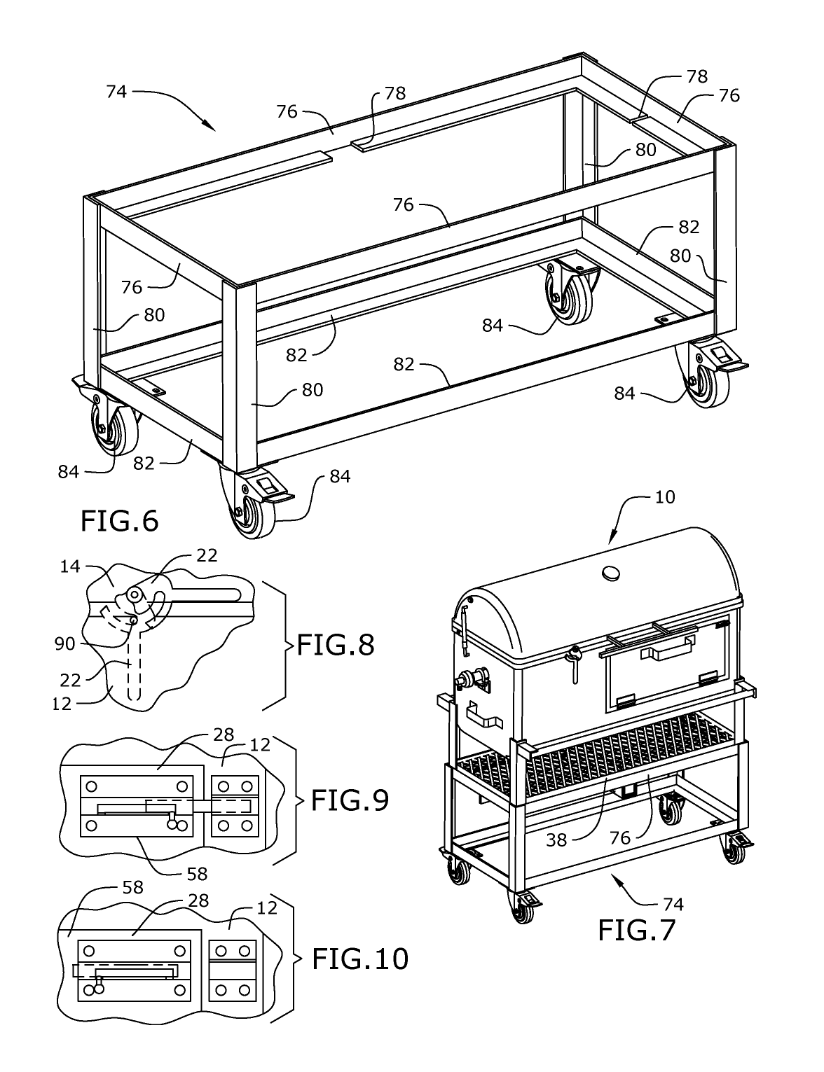

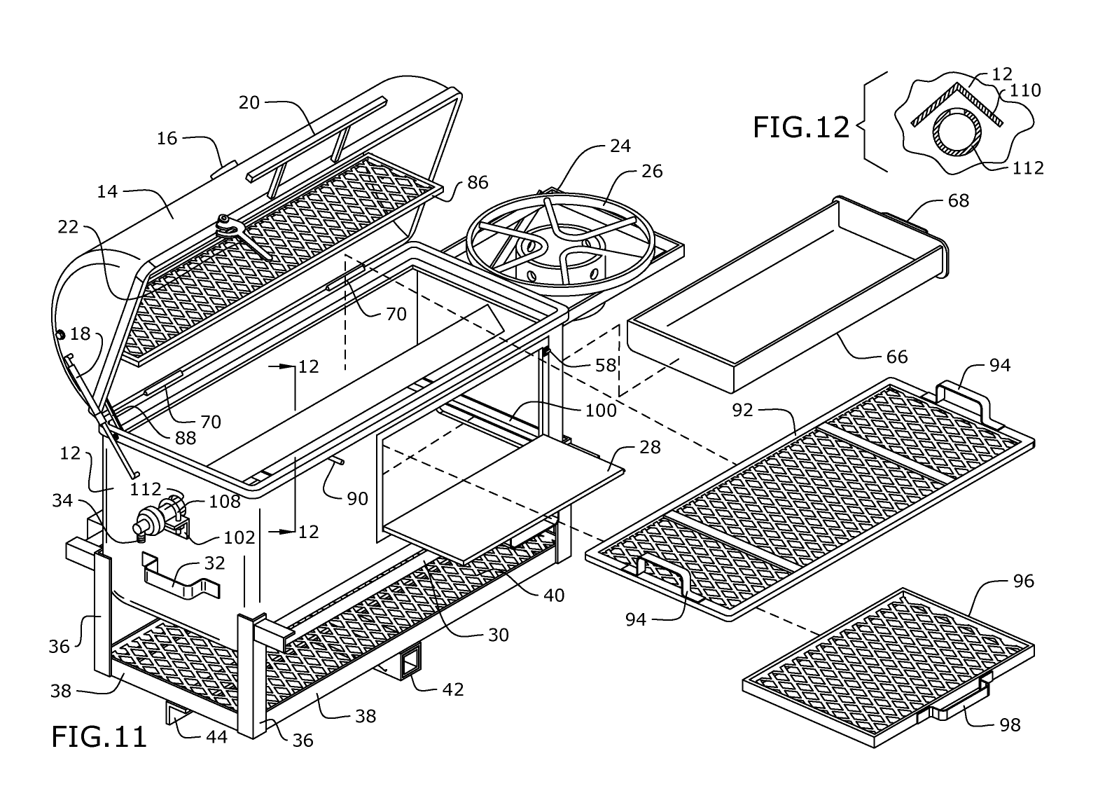

Referring to FIGS. 1 through 12, the present invention may include a portable grill 10 adapted to be supported by a hitch 48 of a vehicle 50 so that the portable grill 10 is disposed outside the vehicle 50 during use and transportation. Typically, but not exclusively, the vehicle 50 will be a truck having a truck gate 52 as the present invention may preferably be considered a tailgating grill. In any event, the vehicle 50 may provide the hitch 48. From the hitch 48, the present invention may include a hitch bar 46 to interconnect to the portable grill 10, thereby affording sufficient tailgating clearance, as illustrated in FIG. 2. It being understood that the various components of the portable grill 10 included herein that are rigidly connected may be connected by welding or other connecting means so as to provide sufficient strength and durability so that the present invention may operate as disclosed herein including, but not limited to, being supported solely when mounted to the vehicle hitch 48 when being transported at high rates of speed.

The portable grill 10 may include a grill body 12 pivotably connected to a cooperating lid 14 by a plurality of lid hinges 70. The grill body 12 and the lid 14 may be dimensioned and adapted to house a grilling space and a charcoal grate 96 and a cooking grate 92, respectively, therein. Each grate 96, 92 may include a handle 98, 94, respectively, for removing said grates 96, 92 to and from the grilling space. The charcoal grate 96 may be supported within the grilling space by a support rail 100. A temperature gauge 16 may be disposed on the lid 14 so that the temperature of the grilling space may be read thereon even when the lid 14 is closed in a closed configuration. Housed within the lid 14 may be a lid cooking grate 86 operably maintained by an orientation arm 88. Extending through the grilling space may be a burner bar 112 and its cover shield 110, as illustrated in FIG. 12. A valve end of the burner bar 112 may protrude through an opening in the side of the grill body 12, whereby it is supported by an L-bracket 102 and a U-clamp 108. A burner valve/nozzle 34 may be disposed on the valve end.

The grill body 12 may be generally cuboid in shape and made of durable material, such as 10 gauge steel metal, though the grill body 12 may be any shape so long as the grill body 12 functions in accordance with the present invention as described herein. The grill body 12 may have a front portion and an opposing rear portion, wherein the rear portion is associated with the lid hinges 70 so that the lid 14 opens to an opened configuration exposing the grilling space on the front portion. It should be understood that the portable grill 10 may support different types of grilling, including gas, charcoal and side burners.

The lid 14 may be movable from the closed configuration to the open configuration by manipulating the lid handle 20, wherein the closed configuration encloses the grilling space. Such movement may be biased by a support piston 18 interconnecting the lid 14 and the grill body 12. In the closed configuration, the lid 14 may be positionable from an unlocked position to a locked position preventing the lid 14 from being moved to the opened configuration. The locked position may be defined by a lid gravity latch 22 rotated so as to be in a locking engagement with a lid gravity pin 90, as illustrated in FIG. 8.

A pair of lift handles 32 may be disposed on opposing sides of the grill body 12 while a pair of lifting bars may be disposed on the rear and front portions of the grill body 12, each pair for manual lifting the grill body 12. Along the front portion of the grill body 12 a charcoal opening may be formed therein so as to communicate with the grilling space. A charcoal door 28 may be pivotably connected along a periphery of the charcoal opening by a pair of door hinges 54. A door handle 56 may be disposed on the charcoal door 28 for manually moving it from a closed position to an open position about the door hinges 54. In the close position, a barrel lock 58 is disposed to span from the charcoal door 28 to the adjacent grill body 12 so as to lock the charcoal door 28.

Disposed along one side of the grill body 12 may be a side burner frame 24 dimensioned and adapted to retain a side burner 26. The side burner frame 24 may be pivotably connected to the grill body 12 by at least one foldout frame hinge 60 so as to be movable from an operable configuration to a storage configuration, as illustrated in FIG. 5. A foldout frame support arm 62 may be pivotably connected to a distal portion of the side burner frame 24, wherein an opposing end of the foldout frame support arm 62 may be engaged by a lock notch bracket 64 so as to prop the side burner frame 24 in the operable configuration, as illustrated in FIG. 4. An ash tray 66 may be disposed along and inward from a lower edge of a side of the grill body 12 so as to be slidably received into a lower portion of the grilling space. The ash tray 66 may be slid in and out of the grilling space by means of an ash tray handle 68.

Opposite the lid 14, the lower portion of the grill body 12 may be rigidly connected (welded) to a lower frame assembly via vertical support columns 36 disposed near each corner of the lower portion of the grill body 12. A lower frame 38 of the lower frame assembly may form a lower opening, wherein the lower frame 38 projects a flange into the lower opening along its periphery. A lower frame grate 40 may be supported by the flange so as to substantially lay over the lower opening. A hitch tube 42 may rigidly connected (welded) to opposing members of the lower frame 38 so as to extend from the front portion to the rear portion. The hitch tube 42 may be dimensioned and adapted to slidably receive the hitch bar 46, as illustrated in FIG. 4. A reinforcement bar 44 may brace the hitch tube 42 near its midpoint, wherein each reinforcement bar 44 is transversely connected to and extends from the hitch tube 42 to the lower frame 38, where it is also rigidly connected. At least one hitch tube pin 72 may be disposed on the hitch tube 42 for locking the hitch bar 46 therein.

The present invention may include a dolly assembly 74 dimensioned and adapted to removably secure the lower frame 38 assembly. The dolly assembly 74 may provide an upper dolly frame 76 and a lower dolly frame 82 rigidly interconnected by a plurality of vertical support columns 80. The upper dolly frame 76 may form notches 78 to receive the hitch tube 42 and the reinforcement bars 44 of the lower frame 38 assembly. The dolly assembly 74 may provide a plurality of casters along a bottom side of the lower dolly frame 82.

A method of using the present invention may include the following. The portable grill 10 disclosed above may be provided. A user may slide the hitch bar 46 from the vehicle hitch 48 into the hitch tube 42 of the lower frame assembly, whereby the user may engage the at least one hitch tube pin 72 to secure said hitch bar 46 so that the portable grill 10 can be transported to outdoor activities and sporting events for tailgating, without taking up important storage space within the vehicle 50. After arrival, the user may disengage the portable grill 10 from the hitch bar 46 so as to secure the lower frame assembly in the support dolly assembly 74 for transporting the grill to a desired location away from the vehicle 50.

It should be understood, of course, that the foregoing relates to exemplary embodiments of the invention and that modifications may be made without departing from the spirit and scope of the invention as set forth in the following claims.

What is claimed is:

1. A portable grill for being secured to a vehicle hitch for transportation and use, comprising:
a grill body made of a durable material; and
a hitch tube made of durable material rigidly connected to a lower portion of the grill body.

2. The portable grill of claim 1, wherein the hitch tube is dimensioned and adapted to mount to the vehicle hitch.

3. The portable grill of claim 1, further comprising a hitch bar made of durable material and adapted so that an end thereof is connected to the vehicle hitch, wherein the hitch tube is dimensioned and adapted to mount to an opposing end of the hitch bar, and wherein the hitch bar is elongated to afford a predetermined tailgate clearance.

4. The portable grill of claim 3, further comprising at least one hitch tube pin disposed along the length of the hitch tube, wherein each hitch tube pin is adapted to secure the hitch bar within the hitch tube.

5. The portable grill of claim 4, wherein the lower portion of the grill body further comprises a lower frame assembly made of a durable material, wherein the hitch tube is rigidly connected to the lower frame assembly.

6. The portable grill of claim 5, wherein the lower frame assembly comprises:
a lower frame comprising a plurality of frame members forming a lower opening; and
a plurality of vertical columns rigidly interconnecting the lower frame to the grill body, wherein the hitch tube is rigidly connected to opposing frame members.

7. The portable grill of claim 6, further comprising two reinforcement bars made of durable material, each reinforcement bar being transversely connected to a midpoint of the hitch tube and extending and connected to an adjacent frame member.

8. The portable grill of claim 7, wherein the durable material is 10 gauge steel metal.

9. The portable grill of claim 7, wherein each rigid connection is formed by welding.

10. The portable grill of claim 7, further comprising a dolly assembly having an upper dolly frame dimensioned and adapted support the lower frame assembly.

11. The portable grill of claim 8, further comprising a plurality of notches disposed along the upper dolly frame, wherein each notch is dimensioned and adapted to receive either the reinforcement bar or the hitch tube.

12. The portable grill of claim 6, wherein the lower frame further comprises a flange projecting into the lower opening.

13. A portable grill for being secured to a vehicle hitch for transportation and use, comprising:
a grill body made of a durable material;
a hitch bar made of durable material adapted so that an end thereof is connected to the vehicle hitch, wherein the hitch bar is elongated to afford a predetermined tailgate clearance;
a hitch tube made of durable material, wherein the hitch tube is dimensioned and adapted to mount to an opposing end of the hitch bar;
at least one hitch tube pin disposed along the length of the hitch tube, wherein each hitch tube pin is adapted to secure the hitch bar within the hitch tube;
a lower frame assembly made of a durable material, comprising:
a lower frame comprising a plurality of frame members forming a lower opening; and
a plurality of vertical columns rigidly interconnecting the lower frame to the grill body, wherein the hitch tube is rigidly connected to opposing frame members; and
two reinforcement bars made of durable material, each reinforcement bar being transversely connected to a midpoint of the hitch tube and extending and connected to an adjacent frame member.

14. The portable grill of claim 13, wherein the durable material is 10 gauge steel metal.

15. The portable grill of claim 14, wherein each rigid connection is formed by welding.

16. The portable grill of claim 13, further comprising a dolly assembly having an upper dolly frame dimensioned and adapted support the lower frame assembly, wherein the upper dolly frame comprising a plurality of notches, each notch dimensioned and adapted to receive either the reinforcement bar or the hitch tube, and wherein the lower frame further comprises a flange projecting into the lower opening.
